(19) United States
(12) Patent Application Publication
(10) Pub. No.: US 2012/0199226 A1
(43) Pub. Date: Aug. 9, 2012

(54) MULTIPLE EMULSIONS CREATED USING JUNCTIONS

(75) Inventors: David A. Weitz, Bolton, MA (US); Mark Romanowsky, Cambridge, MA (US); Christian Holtze, Frankfurt (DE)

(73) Assignees: BASF SE, Ludwigshafen (DE); President and Fellows of Harvard College, Cambridge, MA (US)

(21) Appl. No.: 13/390,584

(22) PCT Filed: Sep. 1, 2010
(86) PCT No.: PCT/US10/47458

§ 371 Date: Apr. 23, 2012

Related U.S. Application Data
(60) Provisional application No. 61/239,402, filed on Sep. 2, 2009.

(51) Int. Cl. F17D 1/00

(52) U.S. Cl. 137/602; 137/1

(57) ABSTRACT

The present invention generally relates to emulsions, and more particularly, to multiple emulsions. In one aspect, multiple emulsions are formed using a plurality of channels, such as microfluidic channels, that meet at a common intersection. The multiple emulsions may be created at a single common intersection in some embodiments, unlike other prior art systems where multiple channel intersections are required to create multiple emulsions. For instance, in one set of embodiments, three, four, or more microfluidic channels may intersect at a common intersection, with two or three serving as inlets and one serving as the outlet. In some embodiments, a first fluidic channel may be relatively hydrophobic, while a second fluidic channel is relatively hydrophilic. The third channel, if present, may be relatively hydrophilic or hydrophobic, depending on the application. The outlet channel may be hydrophobic, hydrophilic, or may comprise at least one portion that is relatively hydrophilic and at least one portion that is relatively hydrophilic. By controlling the flow of fluids through the hydrophilic and hydrophobic portions of the channels, multiple emulsions may be created proximate the common intersection, due to interactions between the fluids entering the common intersection. In other embodiments, different patterns of hydrophilic or hydrophobic channels may be used. Other aspects of the invention are generally directed to methods of making and using such systems, kits involving such systems, emulsions created using such systems, or the like.

### RELATED APPLICATIONS

This application claims the benefit of U.S. Provisional Patent Application Ser. No. 61/239,402, filed Sep. 2, 2009, entitled “Multiple Emulsions Created Using Junctions,” by Weitz, et al., incorporated herein by reference.

### GOVERNMENT FUNDING

Research leading to various aspects of the present invention were sponsored, at least in part, by the National Science Foundation, Grant Nos. DMR0213805, DMR0602684, and DMR0649865. The U.S. Government has certain rights in the invention.

### FIELD OF INVENTION

The present invention generally relates to emulsions, and more particularly, to multiple emulsions.

### BACKGROUND

An emulsion is a fluidic state which exists when a first fluid is dispersed in a second fluid that is typically immiscible with the first fluid. Examples of common emulsions are oil in water and water in oil emulsions. Multiple emulsions are emulsions that are formed with more than two fluids, or two or more fluids arranged in a more complex manner than a typical two-fluid emulsion. For example, a multiple emulsion may be oil-in-water-in-oil (“o/w/o”), or water-in-oil-in-water (“w/o/w”). Multiple emulsions are of particular interest because of current and potential applications in fields such as pharmaceutical delivery, paints, inks and coatings, food and beverage, chemical separations, and health and beauty aids.

Typically, multiple emulsions of a droplet inside another droplet are made using a two-stage emulsification technique, such as by applying shear forces or emulsification through mixing to reduce the size of droplets formed during the emulsification process. Other methods such as membrane emulsification techniques using, for example, a porous glass membrane, have also been used to produce water-in-oil-in-water emulsions. Microfluidic techniques have also been used to produce droplets inside of droplets using a procedure including two or more steps. For example, see International Patent Application No. PCT/US2004/010903, filed Apr. 9, 2004, entitled “Formation and Control of Fluidic Species,” by Link, et al., published as WO 2004/091763 on Oct. 28, 2004; or International Patent Application No. PCT/US03/20542, filed Jun. 30, 2003, entitled “Method and Apparatus for Fluid Dispersion,” by Stone, et al., published as WO 2004/002627 on Jan. 8, 2004, each of which is incorporated herein by reference.

### SUMMARY OF THE INVENTION

The present invention generally relates to emulsions, and more particularly, to multiple emulsions. The subject matter of the present invention involves, in some cases, interrelated products, alternative solutions to a particular problem, and/or a plurality of different uses of one or more systems and/or articles.

In one aspect, the invention is directed to a device. According to one set of embodiments, the device includes at least first, second, third, and fourth fluidic channels intersecting at a common intersection. In some cases, the first fluidic channel is relatively hydrophobic, the second fluidic channel is relatively hydrophilic, and the fourth fluidic channel comprises at least one portion that is relatively hydrophilic and at least one portion that is relatively hydrophilic.

In another set of embodiments, the device includes at least first, second, and third fluidic channels each intersecting at a common intersection. In some instances, at least one of the channels comprises at least one portion that is relatively hydrophilic and at least one portion that is relatively hydrophilic.

The device, in yet another set of embodiments, includes an arrangement of at least first, second, and third fluidic channels each intersecting at a common intersection. In one embodiment, the arrangement comprises a hydrophilic portion including at least one of the fluidic channels and a hydrophobic portion including at least one of the fluidic channels.

In another aspect, the invention is generally directed to a method. According to one set of embodiments, the method includes acts of flowing first, second, and third fluids towards a common intersection, and proximate the intersection, causing the first fluid to surround the second fluid and the second fluid to surround the third fluid to form a multiple emulsion. In some cases, the first fluid and the second fluid are relatively immiscible, and in one embodiment, the second fluid and the third fluid are relatively immiscible.

In another aspect, the present invention is directed to a method of making one or more of the embodiments described herein, for example, a multiple emulsion. In another aspect, the present invention is directed to a method of using one or more of the embodiments described herein, for example, a multiple emulsion.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic diagram of a device according to one embodiment of the invention;

FIG. 2 is a photomicrograph of a device of an embodiment of the invention;

FIG. 3 is a photomicrograph of a multiple emulsion produced in accordance with an embodiment of the invention;

FIG. 4 is a schematic diagram of a device according to yet another embodiment of the invention; and

FIG. 5 is a schematic diagram of a device according to another embodiment of the invention.

### DETAILED DESCRIPTION

The present invention generally relates to emulsions, and more particularly, to multiple emulsions. In one aspect, multiple emulsions are formed using a plurality of channels, such as microfluidic channels, that meet at a common intersection. The multiple emulsions may be created at a single common intersection in some embodiments, unlike other prior art systems where multiple channel intersections are required to create multiple emulsions. For instance, in one set of embodiments, three, four, or more microfluidic channels may intersect at a common intersection, with two or three serving as inlets and one serving as the outlet. In some embodiments, a first fluidic channel may be relatively hydrophobic, while a second fluidic channel is relatively hydrophilic. The third channel, if present, may be relatively hydrophilic or hydrophobic, depending on the application. The outlet channel may be hydrophobic, hydrophilic, or may comprise at least one portion that is relatively hydrophilic and at least one portion that is relatively hydrophilic. By controlling the flow of fluids through the hydrophilic and hydrophobic portions of the channels, multiple emulsions may be created proximate the common intersection, due to interactions between the fluids entering the common intersection. In other embodiments, different patterns of hydrophilic or hydrophobic channels may be used. Other aspects of the invention are generally directed to methods of making and using such systems, kits involving such systems, emulsions created using such systems, or the like.

Thus, in certain embodiments, the present invention generally relates to emulsions, including multiple emulsions, and to methods and apparatuses for making such emulsions. A “multiple emulsion,” as used herein, describes larger droplets that contain one or more smaller droplets therein. In a double emulsion, the larger droplets may, in turn, be contained within another fluid, which may be the same or different than the fluid within the smaller droplet. In certain embodiments, larger degrees of nesting within the multiple emulsion are possible. For example, an emulsion may contain droplets containing smaller droplets therein, where at least some of the smaller droplets contain even smaller droplets therein, etc. Multiple emulsions can be useful for encapsulating species such as pharmaceutical agents, cells, chemicals, or the like. As described below, multiple emulsions can be formed in certain embodiments with generally precise repeatability.

Fields in which emulsions or multiple emulsions may prove useful include, for example, food, beverage, health and beauty aids, paints and coatings, and drugs and drug delivery. For instance, a precise quantity of a drug, pharmaceutical, or other agent can be contained within an emulsion, or in some instances, cells can be contained within a droplet, and the cells can be stored and/or delivered. Other species that can be stored and/or delivered include, for example, biochemical species such as nucleic acids such as siRNA, RNAi and DNA, proteins, peptides, or enzymes, or the like. Additional species that can be incorporated within an emulsion of the invention include, but are not limited to, nanoparticles, quantum dots, fragrances, proteins, indicators, dyes, fluorescent species, chemicals, drugs, or the like. An emulsion can also serve as a reaction vessel in certain cases, such as for controlling chemical reactions, or for in vitro transcription and translation, e.g., for directed evolution technology.

Using the methods and devices described herein, in some embodiments, an emulsion having a consistent size and/or number of droplets can be produced, and/or a consistent ratio of size and/or number of outer droplets to inner droplets (or other such ratios) can be produced for cases involving multiple emulsions. For example, in some cases, a single droplet within an outer droplet of predictable size can be used to provide a specific quantity of a drug. In addition, combinations of compounds or drugs may be stored, transported, or delivered in a droplet. For instance, hydrophobic and hydrophilic species can be delivered in a single, multiple emulsion droplet, as the droplet can include both hydrophilic and hydrophobic portions. The amount and concentration of each of these portions can be consistently controlled according to certain embodiments of the invention, which can provide for a predictable and consistent ratio of two or more species in a multiple emulsion droplet.

The following documents are each incorporated herein by reference: International Patent Application Serial No. PCT/US2008/004097, filed Mar. 28, 2008, entitled “Emulsions and Techniques for Formation,” by Chu, et al., published as WO 2008/121342 on Oct. 9, 2008; International Patent Application No. PCT/US2006/007772, filed Mar. 3, 2006, entitled “Method and Apparatus for Forming Multiple Emulsions,” by Weitz, et al., published as WO 2006/096571 on Sep. 14, 2006; and U.S. Provisional Patent Application Ser. No. 61/160,020, filed Mar. 13, 2009, entitled “Controlled Creation of Emulsions, Including Multiple Emulsions,” by Weitz, et al. Also incorporated herein by reference are U.S. Provisional Patent Application Ser. No. 61/239,405, filed Sep. 2, 2009, entitled “Multiple Emulsions Created Using Jetting and Other Techniques,” by Weitz, et al.; U.S. Provisional Patent Application Ser. No. 61/353,093, filed Jun. 9, 2010, entitled “Multiple Emulsions Created Using Jetting and Other Techniques,” by Weitz, et al.; and U.S. Provisional Patent Application Ser. No. 61/239,402, filed Sep. 2, 2009, entitled “Multiple Emulsions Created Using Junctions,” by Weitz, et al.

In one aspect of the present invention, a plurality of channels intersecting at a common intersection is used to produce a multiple emulsion. One or more of the channels may be a microfluidic channel. As discussed herein, the multiple emulsion may be a double emulsion, a triple emulsion, a quadruple emulsion, etc. For instance, a double emulsion may be formed using three fluidic channels intersecting at a common intersection, a triple emulsion may be formed using four fluidic channels intersecting at a common intersection, a quadruple emulsion may be formed using five fluidic channels intersecting at a common intersection, etc. The channels may all be co-planar, i.e., intersecting in a common plane, or one or more of the channels may approach the common intersection in other, non-planar directions. At the common intersection, the channels may be symmetrically distributed (e.g., at right angles for four channels, at 72° for five channels, at 60° for six channels, etc.), or asymmetrically distributed in some cases.

In the common intersection, the channels may come together such that the center axes of the channels all intersect at a common point, although they need not be. For example, in one embodiment, at the common intersection, one or more of the channels may be offset relative to the other channels. Typically, however, the channels at a common intersection are arranged such that the production of the multiple emulsion droplets occurs due to fluidic interactions between the various channels, as opposed to prior art systems where an emulsion droplet is essentially completely formed before the next droplet nesting is added to the growing multiple emulsion.

In one set of embodiments, the inlet channels may have differing hydrophilicities (or hydrophobicities). The hydrophilicity of a surface can be determined using techniques known to those of ordinary skill in the art, for example, contact angle measurements with water or the like. For instance, a hydrophilic surface may be one in which water forms a contact angle of less than about 60°, while a hydrophobic surface may be one in which water forms a contact angle of greater than about 60°. In some cases, the hydrophilicities of the channels are defined relative to each other. For instance, a first channel may be relatively hydrophobic, relative to a second channel; the second channel would then be relatively hydrophilic, relative to the first channel. Relatively hydrophilicities can be determined using any suitable technique, for example, by comparing their water contact angles with each other; the more hydrophilic surface will be the one with the smaller water contact angle measurement.

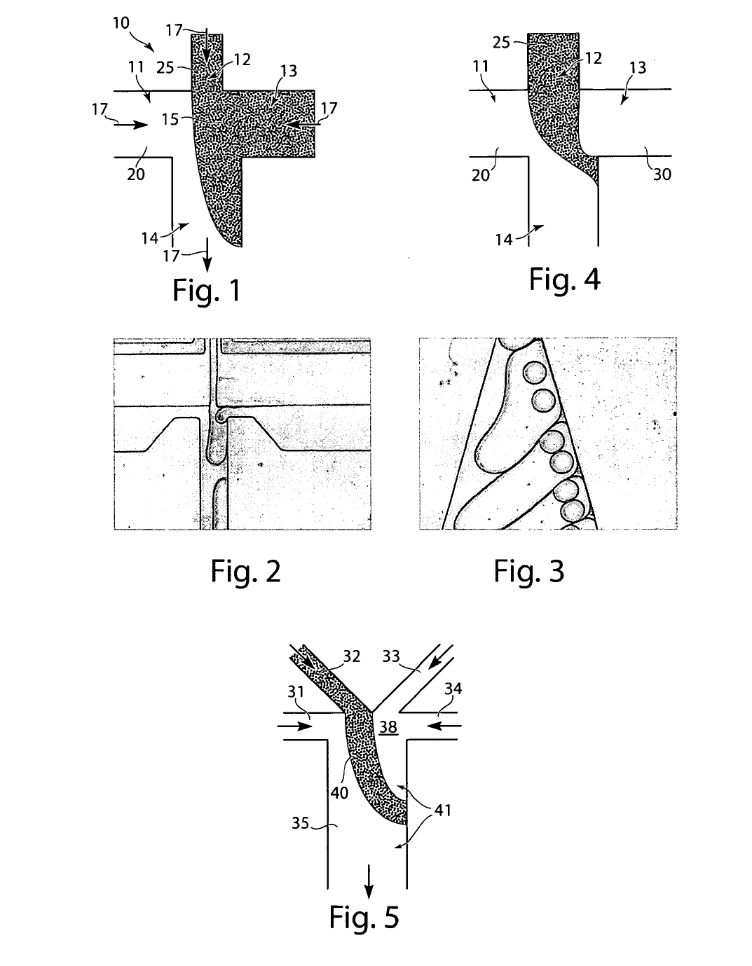

As an illustrative non-limiting example, in one set of embodiments, a device may comprise at least first, second, third, and fourth fluidic channels intersecting at a common intersection. Referring now to the example illustrated in FIG. 1, in device 10, the channels are organized such that a first fluidic channel 11 is relatively hydrophobic, while second and third fluidic channels 12 and 13 are relatively hydrophilic. The fourth fluidic channel 14 may have at least one portion that is relatively hydrophilic and at least one portion that is relatively hydrophilic. These portions may have, in some cases, the same hydrophilicities or hydrophobicities as in the inlet channels. For instance, in FIG. 1, region 25 corresponds to a relatively hydrophilic region within device 10 while region 20 corresponds to a relatively hydrophobic region within the device.

In FIG. 1, first fluidic channel 11 is shown entering the common intersection substantially perpendicular to second fluidic channel 12, which is shown entering the common intersection substantially perpendicular to third fluidic channel 13, which in turn is substantially perpendicular to fourth fluidic channel 14 (which is also substantially perpendicular to first channel 11). It should be noted, however, that other arrangements are also possible in other embodiments of the invention; for example, one or more of the at least first, second, third, and fourth fluidic channels intersecting at a common intersection may meet at angles that are not substantially right angles. In other embodiments, less or more than four channels can be used.

In FIG. 1, an embodiment is illustrated in which the hydrophobic character of the fourth channel increases in a direction away from the intersection. As illustrated, specifically, the relative portion of the fourth channel that is hydrophobic increases in a direction going away from the common intersection. In such a system, to create a oil/water/oil double emulsion, a relatively hydrophobic fluid (e.g., an oil) flows in through the first channel 11, a relatively hydrophilic fluid (e.g., water or an aqueous solution) flows in through the second channel 12, and a relatively hydrophobic fluid (e.g., an oil, which may be the same or different than the one in the first channel) flows in through the third channel 13. Passing through the common intersection into the fourth channel, the relatively hydrophobic fluid in the first channel generally remains in contact with the hydrophobic regions of the channels, while the relatively hydrophilic fluid in the second channel generally remains in contact with the hydrophilic regions. The relatively hydrophobic fluid in the third channel, however, is trapped by the relatively hydrophilic fluid upon entering the common intersection, and thus is inhibited from coming into physical contact with the fluid in the first channel. Thus, as the fluids exit the common intersection, the fluid from the third channel forms an inner droplet, surrounded by an outer droplet (the relatively hydrophilic fluid), which in turn is surrounded by a carrying fluid (the relatively hydrophobic fluid from the first channel), thereby forming a double emulsion.

As mentioned, this process is illustrated by way of example only. In other embodiments, other patterns of hydrophilicities may be present in the device. For example, in one embodiment, the patterns of the hydrophobicities and hydrophilicities discussed with reference to FIG. 1 may be reversed, which may be useful for creating water/oil/water double emulsions (i.e., region 11 may be relatively hydrophilic while region 12 may be relatively hydrophobic). In another embodiment, the third fluidic channel may be relatively hydrophobic, with the hydrophobic portion ending in the common intersection and/or in the fourth fluidic channel. A non-limiting example is illustrated in FIG. 4 with relatively hydrophilic region 25 and relatively hydrophobic regions 20 and 30. In this figure, relatively hydrophilic region 25 ends within the common intersection. In yet other embodiments, one or more of the inlet or outlet channels may have a first, relatively hydrophilic portion and a second, relatively hydrophobic portion. More than one level of hydrophilicity may also be present in one or more of the channels in some cases, e.g., depending on the fluids entering the common channel.

In addition, this system may be extended to five, six, or more channels in other embodiments of the invention, which may be useful for the creation of triple or higher order emulsions. For instance, a triple emulsion may be formed using four fluidic channels intersecting at a common intersection, a quadruple emulsion may be formed using five fluidic channels intersecting at a common intersection, etc. In some cases, alternating arcs of hydrophilic and/or hydrophobic coating may be used to create the various droplets defining the multiple emulsion. In another embodiment, only three channels may be used.

Accordingly, in one embodiment of the present invention, a double emulsion is produced, i.e., an emulsion containing a first, inner fluid, surrounded by a second, outer fluid, which in turn is surrounded by a carrying fluid. In some cases, the carrying fluid and the first fluid may be the same. These fluids are often of varying miscibilities due to differences in hydrophobicity. For example, the inner fluid may be water soluble, the outer fluid oil soluble, and the carrying fluid water soluble. This arrangement is often referred to as a w/o/w multiple emulsion (“water/oil/water”). Another multiple emulsion may include an inner fluid that is oil soluble, an outer fluid that is water soluble, and a carrying fluid that is oil soluble. This type of multiple emulsion is often referred to as an o/w/o multiple emulsion (“oil/water/oil”). It should be noted that the term “oil” in the above terminology merely refers to a fluid that is generally more hydrophobic and not miscible in water, as is known in the art. Thus, the oil may be a hydrocarbon in some embodiments, but in other embodiments, the oil may comprise other hydrophobic fluids. It should also be understood that the water need not be pure; it may be an aqueous solution, for example, a buffer solution, a solution containing a dissolved salt, or the like.

More specifically, as used herein, two fluids are immiscible, or not miscible, with each other when one is not soluble in the other to a level of at least 10% by weight at the temperature and under the conditions at which the emulsion is produced. For instance, two fluids may be selected to be immiscible within the time frame of the formation of the fluidic droplets. In some embodiments, the fluids used to form a multiple emulsion may the same, or different. For example, in some cases, two or more fluids may be used to create a multiple emulsion, and in certain instances, some or all of these fluids may be immiscible. In some embodiments, two fluids used to form a multiple emulsion are compatible, or miscible, while a middle fluid contained between the two fluids is incompatible or immiscible with these two fluids. In other embodiments, however, all three fluids may be mutually immiscible, and in certain cases, all of the fluids do not all necessarily have to be water soluble.

More than two fluids may be used in other embodiments of the invention. Accordingly, certain embodiments of the present invention are generally directed to multiple emulsions, which includes larger fluidic droplets that contain one or more smaller droplets therein which, in some cases, can contain even smaller droplets therein, etc. Any number of nested fluids can be produced, and accordingly, additional third, fourth, fifth, sixth, etc. fluids may be added in some embodiments of the invention to produce increasingly complex droplets within droplets. It should be understood that not all of these fluids necessarily need to be distinguishable; for example, a quadruple emulsion containing oil/water/oil/water or water/oil/water/oil may be prepared, where the two oil phases have the same composition and/or the two water phases have the same composition.

In one set of embodiments, a monodisperse emulsion may be produced. The shape and/or size of the fluidic droplets can be determined, for example, by measuring the average diameter or other characteristic dimension of the droplets. The “average diameter” of a plurality or series of droplets is the arithmetic average of the average diameters of each of the droplets. Those of ordinary skill in the art will be able to determine the average diameter (or other characteristic dimension) of a plurality or series of droplets, for example, using laser light scattering, microscopic examination, or other known techniques. The average diameter of a single droplet, in a non-spherical droplet, is the diameter of a perfect sphere having the same volume as the non-spherical droplet. The average diameter of a droplet (and/or of a plurality or series of droplets) may be, for example, less than about 1 mm, less than about 500 micrometers, less than about 200 micrometers, less than about 100 micrometers, less than about 75 micrometers, less than about 50 micrometers, less than about 25 micrometers, less than about 10 micrometers, or less than about 5 micrometers in some cases. The average diameter may also be at least about 1 micrometer, at least about 2 micrometers, at least about 3 micrometers, at least about 5 micrometers, at least about 10 micrometers, at least about 15 micrometers, or at least about 20 micrometers in certain cases.

The term “determining,” as used herein, generally refers to the analysis or measurement of a species, for example, quantitatively or qualitatively, and/or the detection of the presence or absence of the species. “Determining” may also refer to the analysis or measurement of an interaction between two or more species, for example, quantitatively or qualitatively, or by detecting the presence or absence of the interaction. Examples of suitable techniques include, but are not limited to, spectroscopy such as infrared, absorption, fluorescence, UV/visible, FTIR (“Fourier Transform Infrared Spectroscopy”), or Raman; gravimetric techniques; ellipsometry; piezoelectric measurements; immunoassays; electrochemical measurements; optical measurements such as optical density measurements; circular dichroism; light scattering measurements such as quasielectric light scattering; polarimetry; refractometry; or turbidity measurements.

In various embodiments, the droplets may be of substantially the same shape and/or size (i.e., “monodisperse”), or of different shapes and/or sizes, depending on the particular application. As used herein, the term “fluid” generally refers to a substance that tends to flow and to conform to the outline of its container, i.e., a liquid, a gas, a viscoelastic fluid, etc. Typically, fluids are materials that are unable to withstand a static shear stress, and when a shear stress is applied, the fluid experiences a continuing and permanent distortion. The fluid may have any suitable viscosity that permits flow. If two or more fluids are present, each fluid may be independently selected among essentially any fluids (liquids, gases, and the like) by those of ordinary skill in the art, by considering the relationship between the fluids. In some cases, the droplets may be contained within a carrier fluid, e.g., a liquid. It should be noted, however, that the present invention is not limited to only multiple emulsions. In some embodiments, single emulsions can also be produced.

A “droplet,” as used herein, is an isolated portion of a first fluid that is surrounded by a second fluid. It is to be noted that a droplet is not necessarily spherical, but may assume other shapes as well, for example, depending on the external environment. In one embodiment, the droplet has a minimum cross-sectional dimension that is substantially equal to the largest dimension of the channel perpendicular to fluid flow in which the droplet is located. In some cases, the droplets will have a homogenous distribution of diameters, i.e., the droplets may have a distribution of diameters such that no more than about 10%, about 5%, about 3%, about 1%, about 0.03%, or about 0.01% of the droplets have an average diameter greater than about 10%, about 5%, about 3%, about 1%, about 0.03%, or about 0.01% of the average diameter of the droplets, and correspondingly, droplets within the outlet channel may have the same, or similar, distribution of diameters. Techniques for producing such a homogenous distribution of diameters are also disclosed in International Patent Application No. PCT/US2004/010903, filed Apr. 9, 2004, entitled “Formation and Control of Fluidic Species,” by Link, et al., published as WO 2004/091763 on Oct. 28, 2004, incorporated herein by reference, and in other references as described herein.

The rate of production of droplets may be determined by the droplet formation frequency, which under many conditions can vary between approximately 100 Hz and 5000 Hz. In some cases, the rate of droplet production may be at least about 200 Hz, at least about 300 Hz, at least about 500 Hz, at least about 750 Hz, at least about 1,000 Hz, at least about 2,000 Hz, at least about 3,000 Hz, at least about 4,000 Hz, or at least about 5,000 Hz, etc. In addition, production of large quantities of droplets can be facilitated by the parallel use of multiple devices in some instances. In some cases, relatively large numbers of devices may be used in parallel, for example at least about 10 devices, at least about 30 devices, at least about 50 devices, at least about 75 devices, at least about 100 devices, at least about 200 devices, at least about 300 devices, at least about 500 devices, at least about 750 devices, or at least about 1,000 devices or more may be operated in parallel. The devices may comprise different channels, orifices, microfluidics, etc. In some cases, an array of such devices may be formed by stacking the devices horizontally and/or vertically. The devices may be commonly controlled, or separately controlled, and can be provided with common or separate sources of fluids, depending on the application. Examples of such systems are also described in U.S. Provisional Patent Application Ser. No. 61/160,184, filed Mar. 13, 2009, entitled “Scale-up of Microfluidic Devices,” by Romanowsky, et al., incorporated herein by reference.

The fluids may be chosen such that the inner droplets remain discrete, relative to their surroundings. As non-limiting examples, a fluidic droplet may be created having a carrying fluid, containing a first fluidic droplet, containing a second fluidic droplet. In some cases, the outer fluid and the second fluid may be identical or substantially identical; however, in other cases, the outer fluid, the first fluid, and the second fluid may be chosen to be essentially mutually immiscible. One non-limiting example of a system involving three essentially mutually immiscible fluids is a silicone oil, a mineral oil, and an aqueous solution (i.e., water, or water containing one or more other species that are dissolved and/or suspended therein, for example, a salt solution, a saline solution, a suspension of water containing particles or cells, or the like). Another example of a system is a silicone oil, a fluorocarbon oil, and an aqueous solution. Yet another example of a system is a hydrocarbon oil (e.g., hexadecane), a fluorocarbon oil, and an aqueous solution. Non-limiting examples of suitable fluorocarbon oils include HEF7500, octadecafluorodecahydronaphthalene:

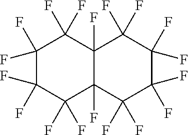

or 1-(1,2,2,3,3,4,4,5,5,6,6-undecafluorocyclohexyl)ethanol:

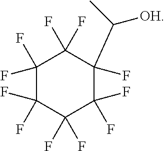

In the descriptions herein, multiple emulsions are often described with reference to a three phase system, e.g., having an outer fluid, a first fluid, and a second fluid. However, it should be noted that this is by way of example only, and that in other systems, additional fluids may be present within the multiple emulsion droplet. Accordingly, it should be understood that the descriptions of the various fluids are by way of ease of presentation, and that the descriptions herein are readily extendable to systems involving additional fluids, e.g., quadruple emulsions, quintuple emulsions, sextuple emulsions, septuple emulsions, etc.

As fluid viscosity can affect droplet formation, in some cases the viscosity of any of the fluids in the fluidic droplets may be adjusted by adding or removing components, such as diluents, that can aid in adjusting viscosity. For example, in some embodiments, the viscosity of the first fluid and the second fluid are equal or substantially equal. This may aid in, for example, an equivalent frequency or rate of droplet formation in the first and second fluids. In other embodiments, the viscosity of the first fluid may be equal or substantially equal to the viscosity of the second fluid, and/or the viscosity of the inner fluid may be equal or substantially equal to the viscosity of the second fluid. In yet another embodiment, the outer fluid may exhibit a viscosity that is substantially different from the first fluid. A substantial difference in viscosity means that the difference in viscosity between the two fluids can be measured on a statistically significant basis. Other distributions of fluid viscosities within the droplets are also possible. For example, the second fluid may have a viscosity greater than or less than the viscosity of the first fluid (i.e., the viscosities of the two fluids may be substantially different), the first fluid may have a viscosity that is greater than or less than the viscosity of the outer fluid, etc. It should also be noted that, in higher-order droplets, e.g., containing four, five, six, or more fluids, the viscosities may also be independently selected as desired, depending on the particular application.

Thus, in certain embodiments of the invention, the fluidic droplets (or a portion thereof) may contain additional entities or species, for example, other chemical, biochemical, or biological entities (e.g., dissolved or suspended in the fluid), cells, particles, gases, molecules, pharmaceutical agents, drugs, DNA, RNA, proteins, fragrance, reactive agents, biocides, fungicides, preservatives, chemicals, or the like. Cells, for example, can be suspended in a fluid emulsion. Thus, the species may be any substance that can be contained in any portion of an emulsion. The species may be present in any fluidic droplet, for example, within an inner droplet, within an outer droplet, etc. For instance, one or more cells and/or one or more cell types can be contained in a droplet.

As discussed, in various aspects of the present invention, multiple emulsions are formed by flowing two, three, or more fluids through various conduits or channels. One or more (or all) of the channels may be microfluidic. “Microfluidic,” as used herein, refers to a device, apparatus or system including at least one fluid channel having a cross-sectional dimension of less than about 1 millimeter (mm), and in some cases, a ratio of length to largest cross-sectional dimension of at least 3:1. One or more channels of the system may be a capillary tube. In some cases, multiple channels are provided. The channels may be in the microfluidic size range and may have, for example, average inner diameters, or portions having an inner diameter, of less than about 1 millimeter, less than about 300 micrometers, less than about 100 micrometers, less than about 30 micrometers, less than about 10 micrometers, less than about 3 micrometers, or less than about 1 micrometer, thereby providing droplets having comparable average diameters. One or more of the channels may (but not necessarily), in cross section, have a height that is substantially the same as a width at the same point. In cross-section, the channels may be rectangular or substantially non-rectangular, such as circular or elliptical.

A “channel,” as used herein, means a feature on or in an article (substrate) that at least partially directs flow of a fluid. The channel can have any cross-sectional shape (circular, oval, triangular, irregular, square or rectangular, or the like) and can be covered or uncovered. In embodiments where it is completely covered, at least one portion of the channel can have a cross-section that is completely enclosed, or the entire channel may be completely enclosed along its entire length with the exception of its inlet(s) and/or outlet(s). A channel may also have an aspect ratio (length to average cross sectional dimension) of at least 2:1, more typically at least 3:1, 5:1, 10:1, 15:1, 20:1, or more. An open channel generally will include characteristics that facilitate control over fluid transport, e.g., structural characteristics (an elongated indentation) and/or physical or chemical characteristics (hydrophobicity vs. hydrophilicity) or other characteristics that can exert a force (e.g., a containing force) on a fluid. The fluid within the channel may partially or completely fill the channel. In some cases where an open channel is used, the fluid may be held within the channel, for example, using surface tension (i.e., a concave or convex meniscus).

The channel may be of any size, for example, having a largest dimension perpendicular to fluid flow of less than about 5 mm or 2 mm, or less than about 1 mm, or less than about 500 microns, less than about 200 microns, less than about 100 microns, less than about 60 microns, less than about 50 microns, less than about 40 microns, less than about 30 microns, less than about 25 microns, less than about 10 microns, less than about 3 microns, less than about 1 micron, less than about 300 nm, less than about 100 nm, less than about 30 nm, or less than about 10 nm. In some cases the dimensions of the channel may be chosen such that fluid is able to freely flow through the article or substrate. The dimensions of the channel may also be chosen, for example, to allow a certain volumetric or linear flowrate of fluid in the channel. Of course, the number of channels and the shape of the channels can be varied by any method known to those of ordinary skill in the art. In some cases, more than one channel or capillary may be used. For example, two or more channels may be used, where they are positioned inside each other, positioned adjacent to each other, positioned to intersect with each other, etc.

As discussed, multiple emulsions such as those described herein may be prepared by controlling the hydrophilicity and/or hydrophobicity of the channels used to form the multiple emulsion, according to various aspects. In one set of embodiments, the hydrophilicity and/or hydrophobicity of the channels may be controlled by coating a sol-gel onto at least a portion of a channel. For instance, in one embodiment, relatively hydrophilic and relatively hydrophobic portions may be created by applying a sol-gel to the channel surfaces, which renders them relatively hydrophobic. The sol-gel may comprise an initiator, such as a photoinitiator. Portions (e.g., channels, and/or portions of channels) may be rendered relatively hydrophilic by filling the channels with a solution containing a hydrophilic moiety (for example, acrylic acid), and exposing the portions to a suitable trigger for the initiator (for example, light or ultraviolet light in the case of a photoinitiator). For example, the portions may be exposed by using a mask to shield portions in which no reaction is desired, by directed a focused beam of light or heat onto the portions in which reaction is desired, or the like. In the exposed portions, the initiator may cause the reaction (e.g., polymerization) of the hydrophilic moiety to the sol-gel, thereby rendering those portions relatively hydrophilic (for instance, by causing poly(acrylic acid) to become grafted onto the surface of the sol-gel coating in the above example).

As is known to those of ordinary skill in the art, a sol-gel is a material that can be in a sol or a gel state, and typically includes polymers. The gel state typically contains a polymeric network containing a liquid phase, and can be produced from the sol state by removing solvent from the sol, e.g., via drying or heating techniques. In some cases, as discussed below, the sol may be pretreated before being used, for instance, by causing some polymerization to occur within the sol.

In some embodiments, the sol-gel coating may be chosen to have certain properties, for example, having a certain hydrophobicity. The properties of the coating may be controlled by controlling the composition of the sol-gel (for example, by using certain materials or polymers within the sol-gel), and/or by modifying the coating, for instance, by exposing the coating to a polymerization reaction to react a polymer to the sol-gel coating, as discussed below.

For example, the sol-gel coating may be made more hydrophobic by incorporating a hydrophobic polymer in the sol-gel. For instance, the sol-gel may contain one or more silanes, for example, a fluorosilane (i.e., a silane containing at least one fluorine atom) such as heptadecafluorosilane, or other silanes such as methyltriethoxy silane (MTES) or a silane containing one or more lipid chains, such as octadecylsilane or other CH₃(CH₂)ₙ-silanes, where n can be any suitable integer. For instance, n may be greater than 1, 5, or 10, and less than about 20, 25, or 30. The silanes may also optionally include other groups, such as alkoxide groups, for instance, octadecyltrimethoxysilane. In general, most silanes can be used in the sol-gel, with the particular silane being chosen on the basis of desired properties such as hydrophobicity. Other silanes (e.g., having shorter or longer chain lengths) may also be chosen in other embodiments of the invention, depending on factors such as the relative hydrophobicity or hydrophilicity desired. In some cases, the silanes may contain other groups, for example, groups such as amines, which would make the sol-gel more hydrophilic. Non-limiting examples include diamine silane, triamine silane, or N-[3-(trimethoxysilyl)propyl] ethylene diamine silane. The silanes may be reacted to form oligomers or polymers within the sol-gel, and the degree of polymerization (e.g., the lengths of the oligomers or polymers) may be controlled by controlling the reaction conditions, for example by controlling the temperature, amount of acid present, or the like. In some cases, more than one silane may be present in the sol-gel. For instance, the sol-gel may include fluorosilanes to cause the resulting sol-gel to exhibit greater hydrophobicity, and other silanes (or other compounds) that facilitate the production of polymers. In some cases, materials able to produce SiO₂ compounds to facilitate polymerization may be present, for example, TEOS (tetraethyl orthosilicate).

It should be understood that the sol-gel is not limited to containing only silanes, and other materials may be present in addition to, or in place of, the silanes. For instance, the coating may include one or more metal oxides, such as SiO₂, vanadia (V₂O₅), titania (TiO₂), and/or alumina (Al₂O₃).

In some instances, the microfluidic channel is present in a material suitable to receive the sol-gel, for example, glass, metal oxides, or polymers such as polydimethylsiloxane (PDMS) and other siloxane polymers. For example, in some cases, the microfluidic channel may be one in which contains silicon atoms, and in certain instances, the microfluidic channel may be chosen such that it contains silanol (Si—OH) groups, or can be modified to have silanol groups. For instance, the microfluidic channel may be exposed to an oxygen plasma, an oxidant, or a strong acid cause the formation of silanol groups on the microfluidic channel.

The sol-gel may be present as a coating on the microfluidic channel, and the coating may have any suitable thickness. For instance, the coating may have a thickness of no more than about 100 micrometers, no more than about 30 micrometers, no more than about 10 micrometers, no more than about 3 micrometers, or no more than about 1 micrometer. Thicker coatings may be desirable in some cases, for instance, in applications in which higher chemical resistance is desired. However, thinner coatings may be desirable in other applications, for instance, within relatively small microfluidic channels.

In one set of embodiments, the hydrophobicity of the sol-gel coating can be controlled, for instance, such that a first portion of the sol-gel coating is relatively hydrophobic, and a second portion of the sol-gel coating is relatively hydrophilic. The hydrophobicity of the coating can be determined using techniques known to those of ordinary skill in the art, for example, using contact angle measurements such as those discussed herein. For instance, in some cases, a first portion of a microfluidic channel may have a hydrophobicity that favors an organic solvent to water, while a second portion may have a hydrophobicity that favors water to the organic solvent.

The hydrophobicity of the sol-gel coating can be modified, for instance, by exposing at least a portion of the sol-gel coating to a polymerization reaction to react a polymer to the sol-gel coating. The polymer reacted to the sol-gel coating may be any suitable polymer, and may be chosen to have certain hydrophobicity properties. For instance, the polymer may be chosen to be more hydrophobic or more hydrophilic than the microfluidic channel and/or the sol-gel coating. As an example, a hydrophilic polymer that could be used is poly(acrylic acid).

The polymer may be added to the sol-gel coating by supplying the polymer in monomeric (or oligomeric) form to the sol-gel coating (e.g., in solution), and causing a polymerization reaction to occur between the polymer and the sol-gel. For instance, free radical polymerization may be used to cause bonding of the polymer to the sol-gel coating. In some embodiments, a reaction such as free radical polymerization may be initiated by exposing the reactants to heat and/or light, such as ultraviolet (UV) light, optionally in the presence of a photoinitiator able to produce free radicals (e.g., via molecular cleavage) upon exposure to light. Those of ordinary skill in the art will be aware of many such photoinitiators, many of which are commercially available, such as Irgacur 2959 (Ciba Specialty Chemicals) or 2-hydroxy-4-(3-triethoxysilylpropoxy)-diphenylketone SIH6200.0, ABCR GmbH & Co. KG).

The photoinitiator may be included with the polymer added to the sol-gel coating, or in some cases, the photoinitiator may be present within the sol-gel coating. For instance, a photoinitiator may be contained within the sol-gel coating, and activated upon exposure to light. The photoinitiator may also be conjugated or bonded to a component of the sol-gel coating, for example, to a silane. As an example, a photoinitiator such as Irgacur 2959 may be conjugated to a silane-isocyanate via a urethane bond, where a primary alcohol on the photoinitiator may participate in nucleophilic addition with the isocyanate group, which may produce a urethane bond.

It should be noted that only a portion of the sol-gel coating may be reacted with a polymer, in some embodiments of the invention. For instance, the monomer and/or the photoinitiator may be exposed to only a portion of the microfluidic channel, or the polymerization reaction may be initiated in only a portion of the microfluidic channel. As a particular example, a portion of the microfluidic channel may be exposed to light, while other portions are prevented from being exposed to light, for instance, by the use of masks or filters, or by using a focused beam of light. Accordingly, different portions of the microfluidic channel may exhibit different hydrophobicities, as polymerization does not occur everywhere on the microfluidic channel. As another example, the microfluidic channel may be exposed to UV light by projecting a de-magnified image of an exposure pattern onto the microfluidic channel. In some cases, small resolutions (e.g., 1 micrometer, or less) may be achieved by projection techniques.

Another aspect of the present invention is generally directed at systems and methods for coating such a sol-gel onto at least a portion of a microfluidic channel. In one set of embodiments, a microfluidic channel is exposed to a sol, which is then treated to form a sol-gel coating. In some cases, the sol can also be pretreated to cause partial polymerization to occur. Extra sol-gel coating may optionally be removed from the microfluidic channel. In some cases, as discussed, a portion of the coating may be treated to alter its hydrophobicity (or other properties), for instance, by exposing the coating to a solution containing a monomer and/or an oligomer, and causing polymerization of the monomer and/or oligomer to occur with the coating.

The sol may be contained within a solvent, which can also contain other compounds such as photoinitiators including those described above. In some cases, the sol may also comprise one or more silane compounds. The sol may be treated to form a gel using any suitable technique, for example, by removing the solvent using chemical or physical techniques, such as heat. For instance, the sol may be exposed to a temperature of at least about 150° C., at least about 200° C., or at least about 250° C., which may be used to drive off or vaporize at least some of the solvent. As a specific example, the sol may be exposed to a hotplate set to reach a temperature of at least about 200° C. or at least about 250° C., and exposure of the sol to the hotplate may cause at least some of the solvent to be driven off or vaporized. In some cases, however, the sol-gel reaction may proceed even in the absence of heat, e.g., at room temperature. Thus, for instance, the sol may be left alone for a while (e.g., about an hour, about a day, etc.), and/or air or other gases may be passed over the sol, to allow the sol-gel reaction to proceed.

In some cases, any ungelled sol that is still present may be removed from the microfluidic channel. The ungelled sol may be actively removed, e.g., physically, by the application of pressure or the addition of a compound to the microfluidic channel, etc., or the ungelled sol may be removed passively in some cases. For instance, in some embodiments, a sol present within a microfluidic channel may be heated to vaporize solvent, which builds up in a gaseous state within the microfluidic channels, thereby increasing pressure within the microfluidic channels. The pressure, in some cases, may be enough to cause at least some of the ungelled sol to be removed or “blown” out of the microfluidic channels.

In certain embodiments, the sol is pretreated to cause partial polymerization to occur, prior to exposure to the microfluidic channel. For instance, the sol may be treated such that partial polymerization occurs within the sol. The sol may be treated, for example, by exposing the sol to an acid or temperatures that are sufficient to cause at least some gellation to occur. In some cases, the temperature may be less than the temperature the sol will be exposed to when added to the microfluidic channel. Some polymerization of the sol may occur, but the polymerization may be stopped before reaching completion, for instance, by reducing the temperature. Thus, within the sol, some oligomers may form (which may not necessarily be well-characterized in terms of length), although full polymerization has not yet occurred. The partially treated sol may then be added to the microfluidic channel, as discussed above.

In certain embodiments, a portion of the coating may be treated to alter its hydrophobicity (or other properties) after the coating has been introduced to the microfluidic channel. In some cases, the coating is exposed to a solution containing a monomer and/or an oligomer, which is then polymerized to bond to the coating, as discussed above. For instance, a portion of the coating may be exposed to heat or to light such as ultraviolet right, which may be used to initiate a free radical polymerization reaction to cause polymerization to occur. Optionally, a photoinitiator may be present, e.g., within the sol-gel coating, to facilitate this reaction.

Additional details of such coatings and other systems may be seen in U.S. Provisional Patent Application Ser. No. 61/040,442, filed Mar. 28, 2008, entitled “Surfaces, Including Microfluidic Channels, With Controlled Wetting Properties,” by Abate, et al.; and International Patent Application Serial No. PCT/US2009/000850, filed Feb. 11, 2009, entitled “Surfaces, Including Microfluidic Channels, With Controlled Wetting Properties,” by Abate, et al., each incorporated herein by reference.

A variety of materials and methods, according to certain aspects of the invention, can be used to form systems (such as those described above) able to produce the multiple droplets described herein. In some cases, the various materials selected lend themselves to various methods. For example, various components of the invention can be formed from solid materials, in which the channels can be formed via micromachining, film deposition processes such as spin coating and chemical vapor deposition, laser fabrication, photolithographic techniques, etching methods including wet chemical or plasma processes, and the like. See, for example, Scientific American, 248:44-55, 1983 (Angell, et al). In one embodiment, at least a portion of the fluidic system is formed of silicon by etching features in a silicon chip. Technologies for precise and efficient fabrication of various fluidic systems and devices of the invention from silicon are known. In another embodiment, various components of the systems and devices of the invention can be formed of a polymer, for example, an elastomeric polymer such as polydimethylsiloxane (“PDMS”), polytetrafluoroethylene (“PTFE” or Teflon®), or the like.

Different components can be fabricated of different materials. For example, a base portion including a bottom wall and side walls can be fabricated from an opaque material such as silicon or PDMS, and a top portion can be fabricated from a transparent or at least partially transparent material, such as glass or a transparent polymer, for observation and/or control of the fluidic process. Components can be coated so as to expose a desired chemical functionality to fluids that contact interior channel walls, where the base supporting material does not have a precise, desired functionality. For example, components can be fabricated as illustrated, with interior channel walls coated with another material. Material used to fabricate various components of the systems and devices of the invention, e.g., materials used to coat interior walls of fluid channels, may desirably be selected from among those materials that will not adversely affect or be affected by fluid flowing through the fluidic system, e.g., material(s) that is chemically inert in the presence of fluids to be used within the device. A non-limiting example of such a coating was previously discussed.

In one embodiment, various components of the invention are fabricated from polymeric and/or flexible and/or elastomeric materials, and can be conveniently formed of a hardenable fluid, facilitating fabrication via molding (e.g. replica molding, injection molding, cast molding, etc.). The hardenable fluid can be essentially any fluid that can be induced to solidify, or that spontaneously solidifies, into a solid capable of containing and/or transporting fluids contemplated for use in and with the fluidic network. In one embodiment, the hardenable fluid comprises a polymeric liquid or a liquid polymeric precursor (i.e. a “prepolymer”). Suitable polymeric liquids can include, for example, thermoplastic polymers, thermoset polymers, or mixture of such polymers heated above their melting point. As another example, a suitable polymeric liquid may include a solution of one or more polymers in a suitable solvent, which solution forms a solid polymeric material upon removal of the solvent, for example, by evaporation. Such polymeric materials, which can be solidified from, for example, a melt state or by solvent evaporation, are well known to those of ordinary skill in the art. A variety of polymeric materials, many of which are elastomeric, are suitable, and are also suitable for forming molds or mold masters, for embodiments where one or both of the mold masters is composed of an elastomeric material. A non-limiting list of examples of such polymers includes polymers of the general classes of silicone polymers, epoxy polymers, and acrylate polymers. Epoxy polymers are characterized by the presence of a three-membered cyclic ether group commonly referred to as an epoxy group, 1,2-epoxide, or oxirane. For example, diglycidyl ethers of bisphenol A can be used, in addition to compounds based on aromatic amine, triazine, and cycloaliphatic backbones. Another example includes the well-known Novolac polymers. Non-limiting examples of silicone elastomers suitable for use according to the invention include those formed from precursors including the chlorosilanes such as methylchlorosilanes, ethylchlorosilanes, phenylchlorosilanes, etc.

Silicone polymers are preferred in one set of embodiments, for example, the silicone elastomer polydimethylsiloxane. Non-limiting examples of PDMS polymers include those sold under the trademark Sylgard by Dow Chemical Co., Midland, Mich., and particularly Sylgard 182, Sylgard 184, and Sylgard 186. Silicone polymers including PDMS have several beneficial properties simplifying fabrication of the microfluidic structures of the invention. For instance, such materials are inexpensive, readily available, and can be solidified from a prepolymeric liquid via curing with heat. For example, PDMSs are typically curable by exposure of the prepolymeric liquid to temperatures of about, for example, about 65° C. to about 75° C. for exposure times of, for example, about an hour. Also, silicone polymers, such as PDMS, can be elastomeric, and thus may be useful for forming very small features with relatively high aspect ratios, necessary in certain embodiments of the invention. Flexible (e.g., elastomeric) molds or masters can be advantageous in this regard.

One advantage of forming structures such as microfluidic structures of the invention from silicone polymers, such as PDMS, is the ability of such polymers to be oxidized, for example by exposure to an oxygen-containing plasma such as an air plasma, so that the oxidized structures contain, at their surface, chemical groups capable of cross-linking to other oxidized silicone polymer surfaces or to the oxidized surfaces of a variety of other polymeric and non-polymeric materials. Thus, components can be fabricated and then oxidized and essentially irreversibly sealed to other silicone polymer surfaces, or to the surfaces of other substrates reactive with the oxidized silicone polymer surfaces, without the need for separate adhesives or other sealing means. In most cases, sealing can be completed simply by contacting an oxidized silicone surface to another surface without the need to apply auxiliary pressure to form the seal. That is, the pre-oxidized silicone surface acts as a contact adhesive against suitable mating surfaces. Specifically, in addition to being irreversibly sealable to itself, oxidized silicone such as oxidized PDMS can also be sealed irreversibly to a range of oxidized materials other than itself including, for example, glass, silicon, silicon oxide, quartz, silicon nitride, polyethylene, polystyrene, glassy carbon, and epoxy polymers, which have been oxidized in a similar fashion to the PDMS surface (for example, via exposure to an oxygen-containing plasma). Oxidation and sealing methods useful in the context of the present invention, as well as overall molding techniques, are described in the art, for example, in an article entitled “Rapid Prototyping of Microfluidic Systems and Polydimethylsiloxane,” Anal. Chem., 70:474-480, 1998 (Duffy, et al.), incorporated herein by reference.

In some embodiments, certain microfluidic structures of the invention (or interior, fluid-contacting surfaces) may be formed from certain oxidized silicone polymers. Such surfaces may be more hydrophilic than the surface of an elastomeric polymer. Such hydrophilic channel surfaces can thus be more easily filled and wetted with aqueous solutions.

In one embodiment, a bottom wall of a microfluidic device of the invention is formed of a material different from one or more side walls or a top wall, or other components. For example, the interior surface of a bottom wall can comprise the surface of a silicon wafer or microchip, or other substrate. Other components can, as described above, be sealed to such alternative substrates. Where it is desired to seal a component comprising a silicone polymer (e.g. PDMS) to a substrate (bottom wall) of different material, the substrate may be selected from the group of materials to which oxidized silicone polymer is able to irreversibly seal (e.g., glass, silicon, silicon oxide, quartz, silicon nitride, polyethylene, polystyrene, epoxy polymers, and glassy carbon surfaces which have been oxidized). Alternatively, other sealing techniques can be used, as would be apparent to those of ordinary skill in the art, including, but not limited to, the use of separate adhesives, bonding, solvent bonding, ultrasonic welding, etc.

The following applications are each incorporated herein by reference: U.S. patent application Ser. No. 08/131,841, filed Oct. 4, 1993, entitled “Formation of Microstamped Patterns on Surfaces and Derivative Articles,” by Kumar, et al., now U.S. Pat. No. 5,512,131, issued Apr. 30, 1996; U.S. patent application Ser. No. 09/004,583, filed Jan. 8, 1998, entitled “Method of Forming Articles including Waveguides via Capillary Micromolding and Microtransfer Molding,” by Kim, et al., now U.S. Pat. No. 6,355,198, issued Mar. 12, 2002; International Patent Application No. PCT/US96/03073, filed Mar. 1, 1996, entitled “Microcontact Printing on Surfaces and Derivative Articles,” by Whitesides, et al., published as WO 96/29629 on Jun. 26, 1996; International Patent Application No.: PCT/US01/16973, filed May 25, 2001, entitled “Microfluidic Systems including Three-Dimensionally Arrayed Channel Networks,” by Anderson, et al., published as WO 01/89787 on Nov. 29, 2001; U.S. patent application Ser. No. 11/246,911, filed Oct. 7, 2005, entitled “Formation and Control of Fluidic Species,” by Link, et al., published as U.S. Patent Application Publication No. 2006/0163385 on Jul. 27, 2006; U.S. patent application Ser. No. 11/024,228, filed Dec. 28, 2004, entitled “Method and Apparatus for Fluid Dispersion,” by Stone, et al., published as U.S. Patent Application Publication No. 2005/0172476 on Aug. 11, 2005; International Patent Application No. PCT/US2006/007772, filed Mar. 3, 2006, entitled “Method and Apparatus for Forming Multiple Emulsions,” by Weitz, et al., published as WO 2006/096571 on Sep. 14, 2006; U.S. patent application Ser. No. 11/360,845, filed Feb. 23, 2006, entitled “Electronic Control of Fluidic Species,” by Link, et al., published as U.S. Patent Application Publication No. 2007/000342 on Jan. 4, 2007; and U.S. patent application Ser. No. 11/368,263, filed Mar. 3, 2006, entitled “Systems and Methods of Forming Particles,” by Garstecki, et al. Also incorporated herein by reference are U.S. Provisional Patent Application Ser. No. 60/920,574, filed Mar. 28, 2007, entitled “Multiple Emulsions and Techniques for Formation,” by Chu, et al.; U.S. Provisional Patent Application Ser. No. 61/239,405, filed Sep. 2, 2009, entitled “Multiple Emulsions Created Using Jetting and Other Techniques,” by Weitz, et al.; and U.S. Provisional Patent Application Serial No. 61/353,093, filed Jun. 9, 2010, entitled “Multiple Emulsions Created Using Jetting and Other Techniques,” by Weitz, et al. In addition, U.S. Provisional Patent Application Serial No. 61/239,402, filed Sep. 2, 2009, entitled “Multiple Emulsions Created Using Junctions,” by Weitz, et al. is also incorporated herein by reference.

The following examples are intended to illustrate certain embodiments of the present invention, but do not exemplify the full scope of the invention.

### EXAMPLE 1

This example illustrates a microfluidic device that makes double emulsions, both schematically and experimentally. Notably, the complete double emulsion in this particular example is formed in a single common intersection, which is formed using a particular non-symmetric pattern of surface chemistry. The design of this device is shown schematically in FIG. 1. In this figure, device 10 includes a first channel 11, a second channel 12, a third channel 13, and a fourth (or outlet) channel 14 all meeting at a common intersection 15. In this example, the channels meet at right angles, although they need not be in other embodiments. First channel 11, second channel 12, and third channel 13 are each inlet channels, as indicated by arrows 17.

Also shown in FIG. 1 is shaded region 25. Shaded region 25 is coated with a hydrophilic coating, which causes the inner oil stream to break off in droplets in the middle water stream, and also guides the water streamlines away from the outer oil; this may help prevent the inner oil droplets from coalescing with the outer oil stream. Unshaded region 20 is coated with a hydrophobic coating, which is wet by the outer oil stream and allows the middle water stream to be pinched off to form a double emulsion drop.

The device shown in FIG. 1 may be created using a two step process. Briefly, the device is treated in a sol-gel process that leaves a hydrophobic layer on all channel surfaces, which also contains photoinitator molecules. Then, the channels are filled with a monomer solution including acrylic acid, and graft polymerization of the hydrophilic polymer poly(acrylic acid) is driven in the indicated areas by exposure to ultraviolet light, for example by a focused beam or through a photomask. The exposed region thus becomes hydrophilic, and the unexposed regions remain hydrophobic. Details of this process are described in U.S. Provisional Patent Application Serial No. 61/040,442, filed Mar. 28, 2008, entitled “Surfaces, Including Microfluidic Channels, With Controlled Wetting Properties,” by Abate, et al.; and International Patent Application Serial No. PCT/US2009/000850, filed Feb. 11, 2009, entitled “Surfaces, Including Microfluidic Channels, With Controlled Wetting Properties,” by Abate, et al., each incorporated herein by reference.

A micrograph of a device that was prepared as described above is illustrated in FIG. 2, and representative double emulsion products produced using this device are shown in FIG. 3. Although this device, as produced, can be used to prepare oil/water/oil double emulsions, by exchanging the hydrophilic and hydrophobic regions water/oil/water double emulsions can also be prepared.

In addition, this device may be extended to triple or higher order emulsions, for example, by adding one or more additional channels terminating at the same intersection, and adding corresponding alternating arcs of hydrophilic and hydrophobic coating. An example of this is illustrated in FIG. 5. In this figure, device 30 includes five channels meeting at a common intersection 38: first channel 31, second channel 32, third channel 33, fourth channel 34, and fifth (outlet) channel 35. First channels 31, 33, and 34 are relatively hydrophilic, while second channel 32 is relatively hydrophobic. The outlet channel 35 has portions that are relatively hydrophilic and portions that are relatively hydrophobic, as is shown in FIG. 5 (shaded portions 40 are hydrophilic, while white portions 41 are hydrophobic). Water may be introduced through channels 32 and 34, while an oil may be introduced through channels 31 and 33.

This device may be used to create w/o/w/o triple emulsion, with water for the innermost phase and oil for the continuous phase. Also, by reversing the positions of the relatively hydrophilic and relatively hydrophobic portions in this device and reversing the oil and water inlets, o/w/o/w emulsions may be created. Other arrangements, e.g., different channel angles, different patterns of the relatively hydrophilic and relatively hydrophobic portions in this device, etc., are also possible.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A device, comprising:
at least first, second, third, and fourth fluidic channels intersecting at a common intersection, wherein the first fluidic channel is relatively hydrophobic, the second fluidic channel is relatively hydrophilic, and the fourth fluidic channel comprises at least one portion that is relatively hydrophilic and at least one portion that is relatively hydrophilic.

2. A device, comprising:
at least first, second, and third fluidic channels each intersecting at a common intersection, wherein at least one of the channels comprises at least one portion that is relatively hydrophilic and at least one portion that is relatively hydrophilic.

3. The device of claim 2, wherein the device comprises at least first, second, third, and fourth fluidic channels.

4. A device, comprising:
an arrangement of at least first, second, and third fluidic channels each intersecting at a common intersection, the arrangement comprising a hydrophilic portion including at least one of the fluidic channels and a hydrophobic portion including at least one of the fluidic channels.

5. The device of claim 4, wherein the arrangement comprises at least first, second, third, and fourth fluidic channels.

6. The device of claim 1, wherein at least one of the fluidic channels is microfluidic.

7. The device of claim 1, wherein each of the fluidic channels is microfluidic.

8. The device of claim 1, wherein the second and third fluidic channels are each relatively hydrophilic.

9. The device of claim 1, wherein the first and third fluidic channels are each relatively hydrophobic.

10. The device of claim 1, wherein the at least one portion of the fourth fluidic channel that is relatively hydrophilic has substantially the same hydrophilicity as the second fluidic channel.

11. The device of claim 1, wherein the at least one portion of the fourth fluidic channel that is relatively hydrophobic has substantially the same hydrophobicity as the first fluidic channel.

12. The device of claim 1, wherein the first fluidic channel is rendered relatively hydrophobic due to a hydrophobic coating on the first fluidic channel.

13. The device of claim 1, wherein the second fluidic channel is rendered relatively hydrophilic due to a hydrophilic coating on the second fluidic channel.

14. The device of claim 1, wherein the second fluidic channel comprises a surface coating of poly(acrylic acid).

15. The device of claim 1, wherein the first fluidic channel comprises a surface coating of a sol-gel.

16. The device of claim 1, wherein the first fluidic channel and the second fluidic channel intersect at substantially right angles.

17. The device of claim 1, wherein the second fluidic channel and the third fluidic channel intersect at substantially right angles.

18. The device of claim 1, wherein the first fluidic channel and the fourth fluidic channel intersect at substantially right angles.

19. The device of claim 1, wherein the first, second, third, and fourth fluidic channels intersecting at a common intersection intersect at right-angles.

20. The device of claim 1, wherein the at least first, second, third, and fourth fluidic channels are coplanar.

21. The device of claim 1, the device comprising only four fluidic channels at the common intersection.

22. A method, comprising:
flowing first, second, and third fluids towards a common intersection, the first fluid and the second fluid being relatively immiscible and the second fluid and the third fluid being relatively immiscible; and
proximate the intersection, causing the first fluid to surround the second fluid and the second fluid to surround the third fluid to form a multiple emulsion.

23. The method of claim 22, wherein at least one of the fluids is contained within a microfluidic channel.

24. The device of claim 22, wherein each of the fluids is contained within a microfluidic channel.

25. The device of claim 22, wherein at least one microfluidic channel is relatively hydrophilic.

26. The device of claim 23, wherein at least one microfluidic channel is relatively hydrophobic.
